(19) United States
(12) Patent Application Publication
(10) Pub. No.: US 2015/0144311 A1
(43) Pub. Date: May 28, 2015

(54) COMBINED COOLING AND FIRE SUPPRESSION SYSTEM

(71) Applicant: Michel Grabon, Bressolles (FR)

(72) Inventor: Michel Grabon, Bressolles (FR)

(73) Assignee: CARRIER CORPORATION, Farmington (CT)

(21) Appl. No.: 14/401,583

(22) PCT Filed: May 24, 2012
(86) PCT No.: PCT/IB2012/001191

§ 371 Date: Nov. 17, 2014

(51) Int. Cl. F28F 7/00; A62C 37/44; A62C 3/00

(52) U.S. Cl. CPC F28F 7/00; A62C 3/00; A62C 37/44
USPC 165/138

(57) ABSTRACT

A combined cooling and fire suppression system for a protected space includes a refrigerant circuit circulating a flow of refrigerant therethrough. At least one fan coil assembly is disposed at the protected space and is operably connected to the refrigerant circuit. The fan coil assembly includes a coil in fluid communication with the refrigerant circuit such that the flow of refrigerant is directed therethrough, and a fan to direct a flow of air across the coil to cool the protected space in proximity to the fan coil assembly. A plurality of nozzles is located in fluid communication with the refrigerant circuit to direct the flow of refrigerant from the refrigerant circuit toward the protected space to suppress fire thereat.

### BACKGROUND OF THE INVENTION

The subject matter disclosed herein relates to cooling systems and fire suppression systems. Spaces, such as office buildings, residential buildings, industrial buildings, or portions thereof, such as “data centers” utilized to house computer systems and associated components, such as telecommunications and storage systems, often require climate control systems for cooling and/or heating as well as a separate fire suppression system for the space. A typical cooling system utilizes a liquid refrigerant piping system to provide cooling to the space via fan coils located at the space. Further, the fire suppression system protects the space from fire and extinguishes fires that occur in the space. The typical fire suppression system includes a separate fluid piping network with nozzles placed at locations throughout the space to spray the fire suppression material when necessary.

### BRIEF DESCRIPTION OF THE INVENTION

In one embodiment, a combined cooling and fire suppression system for a protected space includes a refrigerant circuit circulating a flow of refrigerant therethrough. At least one fan coil assembly is disposed at the protected space and is operably connected to the refrigerant circuit. The fan coil assembly includes a coil in fluid communication with the refrigerant circuit such that the flow of refrigerant is directed therethrough, and a fan to direct a flow of air across the coil to cool the protected space in proximity to the fan coil assembly. A plurality of nozzles is located in fluid communication with the refrigerant circuit to direct the flow of refrigerant from the refrigerant circuit toward the protected space to suppress fire thereat.

In another embodiment, a data center includes a plurality of computer components. A refrigerant circuit circulates a flow of refrigerant therethrough. The data center further includes a plurality of fan coil assemblies, each fan coil assembly located proximate to a computer component of the plurality of computer components. Each fan coil assembly includes a coil in fluid communication with the refrigerant circuit such that the flow of refrigerant is directed therethrough, and a fan to direct a flow of air across the coil to cool the computer component proximate to the fan coil assembly. A plurality of nozzles is located in fluid communication with the refrigerant circuit to direct the flow of refrigerant from the refrigerant circuit toward the computer component to suppress fire thereat.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of an embodiment of a cooling and fire suppression system for a protected space; and

FIG. 2 is a schematic view of an embodiment of a fan coil assembly.

The detailed description explains embodiments of the invention, together with advantages and features, by way of example with reference to the drawing.

### DETAILED DESCRIPTION OF THE INVENTION

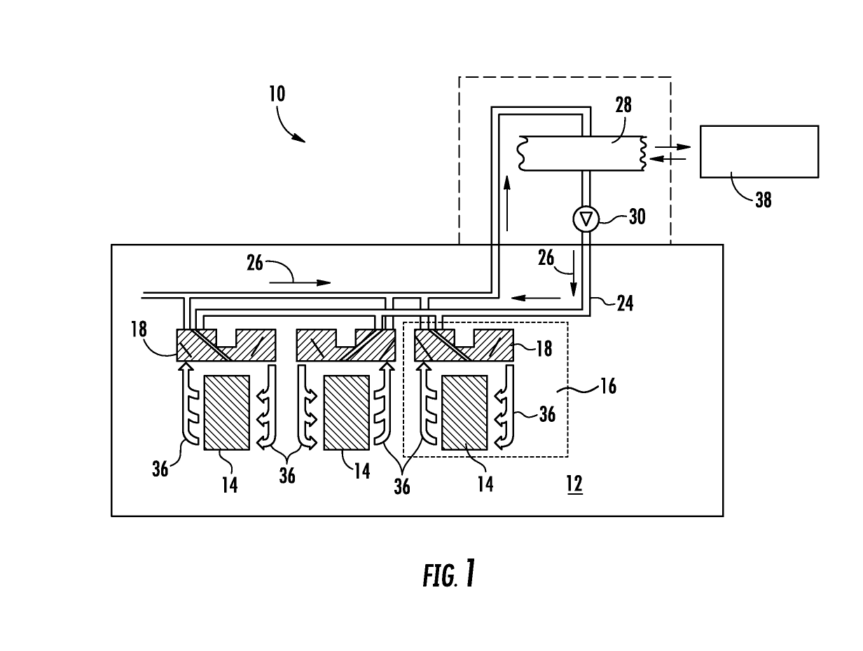

Shown in FIG. 1 is an embodiment of an integrated fire suppression and cooling system 10 for a protected space 12. The fire suppression and cooling system 10 includes a number of fan coil assemblies 18 located throughout the protected space 12, for example, at a ceiling of the protected space 12. It is to be appreciated, however, that locating the fan coil assemblies 18 at the ceiling of the protected space 12 is merely an exemplary arrangement, and in other embodiments the fan coil assemblies 18 may be located elsewhere in the protected space 12. The fan coil assemblies 18 are connected to a refrigerant circuit 24 through which a flow of refrigerant 26 is circulated. The flow of refrigerant 26, as a liquid, is urged from a condenser 28 through the refrigerant circuit 24 toward the fan coil assemblies 18 via a pump 30. The flow of refrigerant 26 flows through the fan coil assemblies 18, where it is at least partially vaporized. The flow of refrigerant 26 returns to the condenser 28 via the refrigerant circuit 24 and is condensed to liquid by thermal energy exchange between the condenser 28 and, for example, a chiller 38.

In some embodiments, the protected space 12 is a data center including a plurality of computer systems 14, with the fan coil assemblies 18 located above the computer systems 14, such as one fan coil assembly 18 above each computer system. Alternatively, the fan coil assemblies 18 are located along a side of the computer systems 14 or beneath the computer systems 14. It is to be appreciated that the system 10 may be applied to a variety of protected spaces 12 other than a data center.

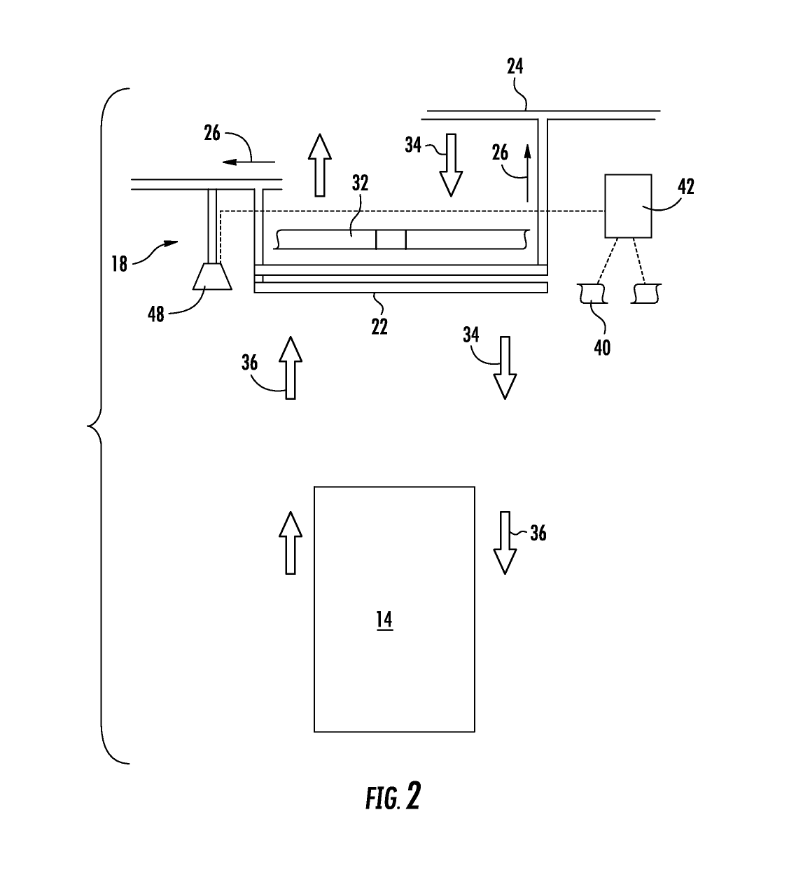

Referring now to FIG. 2, each fan coil assembly 18 includes a coil 22 connected to the refrigerant circuit 24. The liquid flow of refrigerant 26 is circulated through each coil 22, where a variable speed fan 32 urges a flow of air 34 across the coil 22 and downwardly into the protected space 12, thus cooling the protected space 12. The fan 32 establishes a convective flow 36 such that air flowing from the protected space 12 to the fan coil assembly 18 vaporizes the flow of refrigerant 26 in the coil 22. The vaporized flow of refrigerant 26 then returns to the condenser 28 via the refrigerant circuit 24 as stated above. Temperature sensors 40 are located in the protected space 12, for example, at each fan coil assembly 18. The temperature sensors 40 are operably connected to fan coil controllers 42, and depending on a temperature sensed by the temperature sensors 40, the controllers 42 direct operation of the fans 32, for example, turning the fans 32 on or off, or changing speed of the fans 32. Each fan coil assembly 18 may have an independent controller 42, or alternatively a central controller 42 may control operation of all or a portion of the fans 32, either as a group or individually, turning individual fans 32 on or off, or changing speeds of individual fans 32.

The system 10 further includes the ability for fire detection and suppression, rather than requiring a separate fire suppression system for the protected space 12. A plurality of fire suppression nozzles 48 are disposed in the protected space 12 and are connected to the refrigerant circuit 24. The flow of refrigerant 26 circulated through the refrigerant circuit 24 is selected to be capable of fire suppression, and in some embodiments is CO₂ or HFC 227ea. In some embodiments, the nozzles 48 are part of the fan coil assemblies 18. Further, the fan coil assemblies 18 may include fire sensors, which may include smoke detectors and/or temperature sensors 40. In operation, when a fire is detected at a particular fan coil assembly 18 over a particular portion 16 of the protected space 12 by the temperature sensors 40, the nozzle 48 or nozzles 48 at the fan coil assembly 18 are activated to spray refrigerant 26 over the portion 16 of the protected space 12 to extinguish the fire. The fire sensors and nozzles 48 may be controlled by controllers 42.

Use of fire sensors and nozzles 48 located at each fan coil assembly 18, allows for precise fire detection at the particular portion 16 of the protected space 12, and further to allow for focused suppression of fire at the affected portion of the protected space 12. Utilizing the same refrigerant circuit 24 for cooling of the protected space 12 and for suppression of fire at the protected space 12 eliminates the need for separate fire suppression and cooling systems for the protected space 12.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combined cooling and fire suppression system for a protected space comprising:
a refrigerant circuit circulating a flow of refrigerant therethrough;
at least one fan coil assembly disposed at the protected space and operably connected to the refrigerant circuit including:
a coil in fluid communication with the refrigerant circuit such that the flow of refrigerant flows therethrough; and
a fan to direct a flow of air across the coil to cool the protected space proximate to the fan coil assembly; and
a plurality of nozzles in fluid communication with the refrigerant circuit to direct the flow of refrigerant from the refrigerant circuit toward the protected space to suppress fire thereat.

2. The system of claim 1, further comprising one or more controllers operably connected to the system to control operation of the fan and/or the plurality of nozzles.

3. The system of claim 2, further comprising one or more temperature sensors operably connected to the one or more controllers.

4. The system of claim 2, wherein a temperature sensor is disposed at each fan coil assembly of the at least one fan coil assembly.

5. The system of claim 1, wherein at least one nozzle of the plurality of nozzles is disposed at each fan coil assembly of the at least one fan coil assembly.

6. The system of claim 1, wherein the refrigerant is configured for both cooling and fire suppression.

7. The system of claim 6, wherein the refrigerant is one of CO₂ or HFC 227ea.

8. The system of claim 1, wherein the fan coil assembly is disposed at a ceiling of the protected space.

9. A data center comprising:
a plurality of computer components;
a refrigerant circuit circulating a flow of refrigerant therethrough;
a plurality of fan coil assemblies, each fan coil assembly disposed proximate to a computer component of the plurality of computer components, each fan coil assembly including:
a coil in fluid communication with the refrigerant circuit such that the flow of refrigerant is directed therethrough; and
a fan to direct a flow of air across the coil to cool the computer component proximate to the fan coil assembly; and
a plurality of nozzles in fluid communication with the refrigerant circuit to direct the flow of refrigerant from the refrigerant circuit toward the computer component to suppress fire thereat.

10. The data center of claim 9, further comprising one or more controllers operably connected to the plurality of fan coil assemblies and/or the plurality of nozzles to control operation of the fan and/or the plurality of nozzles.

11. The data center of claim 10, further comprising one or more temperature sensors operably connected to the one or more controllers.

12. The data center of claim 10, wherein a temperature sensor is disposed at each fan coil assembly of the plurality of fan coil assemblies.

13. The data center of claim 9, wherein the at least one nozzle of the plurality of nozzles is disposed at each fan coil assembly of the at least one fan coil assembly.

14. The data center of claim 9, wherein the flow of refrigerant is configured for both cooling and fire suppression.

15. The data center of claim 14, wherein the flow of refrigerant is one of CO₂ or HFC 227ea.

16. The data center of claim 9, wherein the fan coil assembly is disposed above the computer system.
